(19) United States
(12) Patent Application Publication
(10) Pub. No.: US 2008/0319925 A1
(43) Pub. Date: Dec. 25, 2008

(54) Computer Hardware Metering

(75) Inventors: Jeffrey Alan Herold, Bellevue, WA (US); James S. Duffus, Seattle, WA (US); Curt Andrew Steeb, Redmond, WA (US); Thomas G. Phillips, Bellevue, WA (US); William J. Westerinen, Issaquah, WA (US); Martin H. Hall, Sammamish, WA (US); Todd L. Carpenter, Monroe, WA (US); Daniel Makoski, Redmond, WA (US); Shon Schmidt, Seattle, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/766,595

(22) Filed: Jun. 21, 2007

(51) Int. Cl. H04K 1/00; G06F 17/00; H04L 9/00

(52) U.S. Cl. 705/400; 705/50

(57) ABSTRACT

A computer or other electronic device may be used in one of several selectable modes of operation. Computer resources, such as a processor, memory, or a graphics controller, are individually settable for operation at different levels of performance. A mode of operation or performance level is determined by the combination of individual settings for the various resources. Pay-per-use operation is charged at a rate determined by the mode of operation or performance level. Operation in a gaming mode may be charged at a higher rate than operation in web-browsing mode. A metering agent may be associated with each scalable use resource to securely set the performance level and to securely report on metered operation of the resource.

This application is related to co-pending U.S. patent application with attorney docket number 30835/320367 entitled, “Metered Pay-As-You Go Computing Experience,” filed on the same day as this application and is incorporated by reference for all purposes.

### BACKGROUND

The current business model for computer hardware and software relies on a user purchasing a computer with hardware and software that is suited to the most demanding applications that the user expects to encounter. Therefore, a user may buy a multi-core processor with a significant amount of memory and advanced video support for gaming applications that are only used on the weekend, while the user's day-in, day-out activities may involve little more than word processing or web-browsing.

The business model extends to other technology areas. An in-vehicle mapping and directions appliance may be invaluable during a trip to unfamiliar territory, but for normal trips for shopping and school-related activities, the appliance may not even be turned on.

Similarly, software purchased for specific work or recreational activities may lie dormant for extended periods of time when the user is occupied with other activities. An advanced graphics package may lie unused until it is time for a graduation invitation or an annual Christmas letter with integrated photos and seasonal graphics.

For hardware and software manufacturers and resellers, this business model requires more or less a one chance at the consumer kind of mentality, where elasticity curves are based on the pressure to maximize profits on a one-time sale, one-shot-at-the-consumer mentality.

### SUMMARY

A different business model may allow a more granular approach to hardware and software sales. A computer may have individually metered hardware and software components that a user can select and activate based on current need. Beyond simple activation, the user may be able to select a level of performance related to processor, memory, graphics power, etc. that is driven not by a lifetime maximum requirement, but rather by the need of the moment. When the need is browsing, a low level of performance may be used and when network-based interactive gaming is the need of the moment, the highest available performance may be made available to the user.

As may be expected, when the user has minimal resource needs, the cost associated with use should be minimal, and a higher cost may be associated with a ‘pull out the stops’ level of performance. Because the user only pays for the performance level of the moment, the user may see no reason to not acquire a device with a high degree of functionality, in terms of both hardware and software, and experiment with a usage level that suits different performance requirements.

Because hardware yields and software duplication costs allow very low cost on the margin of increased performance, manufacturers and software developers may see an overall increase in revenues when their product is available to users on a per-access or subscription basis that reflects actual consumption. Certainly the overall technology experience is that when given an opportunity to have increased capability, users migrate to it. Thus, users get the performance they want and sellers get incremental sales from a greatly-expanded user base that would have never considered a one-time purchase of a fairly exotic-looking and high-price hardware or software component.

To make this model successful, a mechanism must be in place that supports a highly secure method of adjusting performance coupled with a secure, auditable measurement and payment scheme to allow a variety of pre-paid and post-paid mechanisms for capturing and settling highly granular, infinitely adjustable, performance variations. Such a mechanism may include selected performance-adjustable components and a secure execution environment that can manage policies, usage metering, and secure communications with the performance-adjustable components. The secure execution environment may also include a stored value capability for self-contained billing of operation under different performance profiles. Conversely, the secure execution environment may also store billing information for uploading to a billing system in a post-paid business model.

In practice, operation at different levels of performance may be selected for individual components or operation of the computer at different overall levels may be presented as a ‘bundle.’ Other options may be supported, such as development of a custom bundle. One or more performance characteristics of each component may be individually tunable in one embodiment. In another embodiment, performance characteristics may only be available in quantized steps. For each level of performance, a value per unit of usage may be assigned.

Accounting for usage at a given level may be according to different criteria. For example, value associated with usage may accounted for by elapsed time, active time, actual use of the component, etc. Billing may be through a local pre-paid mechanism, such as a stored value account, a remote post-paid account, or other known payment types. In one embodiment, the billed value is accumulated according to both usage time and a composite of performance characteristics for scalable components.

This model, and the mechanisms that support it, are different from those associated with preview, or demo-mode graphics. In a demo or preview, a limited-function application is presented for use. In some cases, features are permanently disabled while in other cases, the ability to save results is restricted. Other methods of presenting a limited-function application may also be used. What such applications have in common is the ability to buy a one-time license that either downloads a full-function version of the application or removes a block on the demo to allow full function of the application. Usage of the application is neither metered nor reversible.

### BRIEF DESCRIPTION OF THE DRAWINGS

FIG. 1 is a block diagram showing a system-level view with elements of a hardware-based metering system;

FIG. 2 is a block diagram of showing an electronic device in the form of a computer supporting scalable resource usage;

FIG. 3 is a block diagram showing selected portions of a computer similar to that of FIG. 2 in more detail;

FIG. 4 is a block diagram of a representative metering agent;

FIG. 5 is a block diagram of a representative security module; and

FIG. 6 is a flow chart representing a method of managing a scalable resources in a pay-per-use electronic device.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

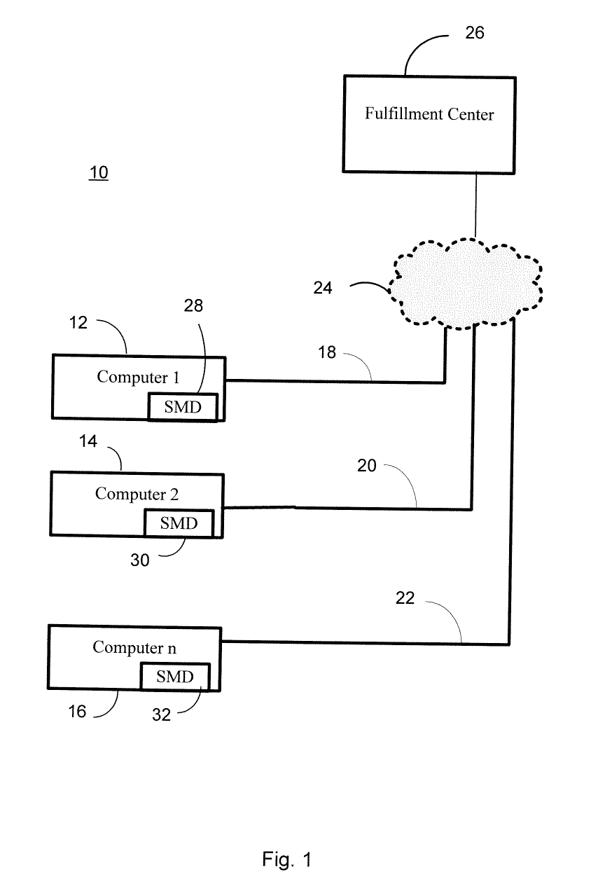

FIG. 1 is a block diagram of a system for managing pay-per-use computers in a networked environment. Pay-per-use computers may be installed by an agreement with a service provider that may lower the initial investment in the computers in exchange for a contract requiring additional purchases over a period of time. The contract may be implemented in many different forms, for example, a monthly subscription for a number of months or a number of usage minute purchases within a given period of time.

The system 10 may include a number of pay-per-use computers, such as a first computer 12, a second computer 14, and a representative last computer 16. The computers may be connected over individual local access connections 18, 20, 22 to a wide area network 24, such as the Internet, and from there to a fulfillment center 26. The local access connection may be wired or wireless and may include additional routers or connections, both public and private. The fulfillment center 26 may process requests for add-value packets and may be connected to financial institutions or other service providers and underwriters (not depicted). The underwriters may provide the computers for a subsidized price in exchange for a financial commitment from a system operator. The fulfillment center 26 may have cryptographic keys for supporting authentication and value-add transactions with the pay-per-use computers 12, 14, 16. The fulfillment center 26 may also support connections to financial institutions associated with owners/operators of the individual computers 12, 14, 16.

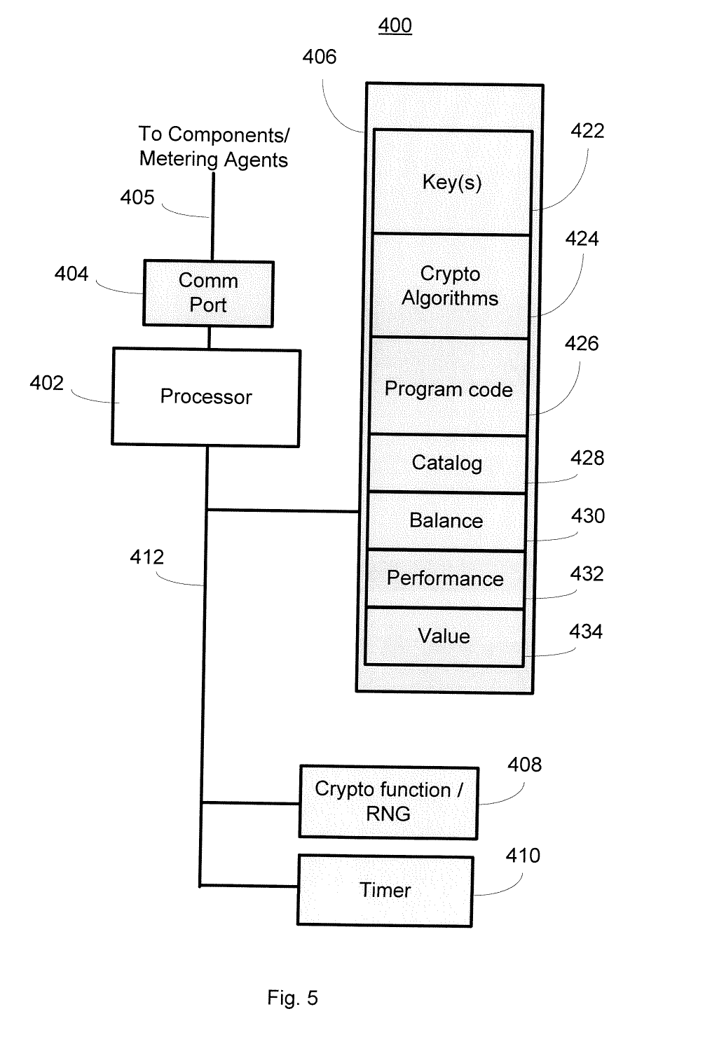

Each computer 12, 14, 16 may have a respective security module 28, 30, and 32. The security module is discussed in more detail with respect to FIG. 5, but briefly, each security module 28, 30, 32 may have a processor, a secure memory, and a cryptographic function, implemented in hardware or software, for supporting metering operations, value add packet processing, and self-sanctioning of pay-per-use computers not in compliance with their contractual terms.

In operation, the pay-per-use computers 12, 14, 16 be configured for use in several modes of operation. Operation in each mode may be charged at a different rate, according to the configuration of internal resources, the value to the end-user, etc.

Initial configuration of pay-per-use computers 12, 14, 16 may involve not only the installation of keys binding the pay-per-use computers 12, 14, 16 to the fulfillment center 26, but also installation of keys used for internal configuration and communication of scalable internal resources that set operation in a particular mode. Additionally, software or firmware in the pay-per-use computers 12, 14, 16 may be installed or activated.

Several different instantiations of operating mode management and recharging are discussed below to illustrate a few of the possible variations. In one embodiment, each computer's respective security module 28, 30, 32 may consume value packets during operation. When usage value reaches a low limit, the security modules 28, 30, 32 may initiate a process that allows purchase more time from the fulfillment center 26. Further discussion of scalable-use operation and charging/billing follows.

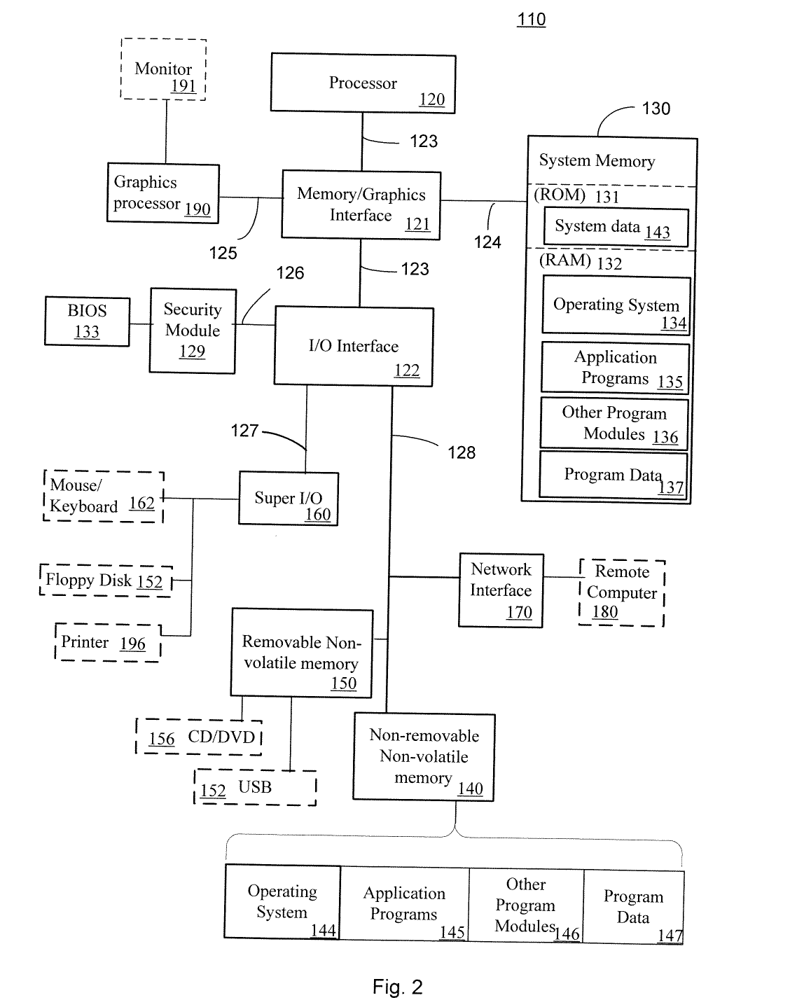

With reference to FIG. 2, an exemplary system for implementing the claimed method and apparatus includes a general purpose computing device in the form of a computer 110. Components shown in dashed outline are not technically part of the computer 110, but are used to illustrate the exemplary embodiment of FIG. 2. Components of computer 110 may include, but are not limited to, a processor 120, a system memory 130, a memory/graphics interface 121, also known as a Northbridge chip, and an I/O interface 122, also known as a Southbridge chip. The system memory 130 and a graphics processor 190 may be coupled to the memory/graphics interface 121. A monitor 191 or other graphic output device may be coupled to the graphics processor 190.

A series of system busses may couple various system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 123 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by processor 120. By way of example, and not limitation, FIG. 2 illustrates operating system 134, application programs 135, other program modules 136, and program data 137.

The I/O interface 122 may couple the system bus 123 with a number of other busses 126, 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up.

In some embodiments, a security module 129 may be incorporated to manage metering, billing, and enforcement of policies. The security module is discussed more below, especially with respect to FIG. 5.

A super input/output chip 160 may be used to connect to a number of ‘legacy’ peripherals, such as floppy disk 152, keyboard/mouse 162, and printer 196, as examples. The super I/O chip 160 may be connected to the I/O interface 122 with a low pin count (LPC) bus, in some embodiments. The super I/O chip 160 is widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

The computer 110 may also include other removable/non-removable, volatile/nonvolatile computer storage media. By way of example only, FIG. 2 illustrates a hard disk drive 140 that reads from or writes to non-removable, nonvolatile magnetic media. Removable media, such as a universal serial bus (USB) memory 152 or CD/DVD drive 156 may be connected to the PCI bus 128 directly or through an interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 110. In FIG. 2, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a mouse/keyboard 162 or other input device combination. Other input devices (not shown) may include a microphone, joystick, game pad, satellite dish, scanner, or the like. These and other input devices are often connected to the processor 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may operate in a networked environment using logical connections to one or more remote computers, such as a remote computer 180 via a network interface controller (NIC) 170,. The remote computer 180 may be a personal computer, a server, a router, a network PC, a peer device or other common network node, and typically includes many or all of the elements described above relative to the computer 110. The logical connection between the NIC 170 and the remote computer 180 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

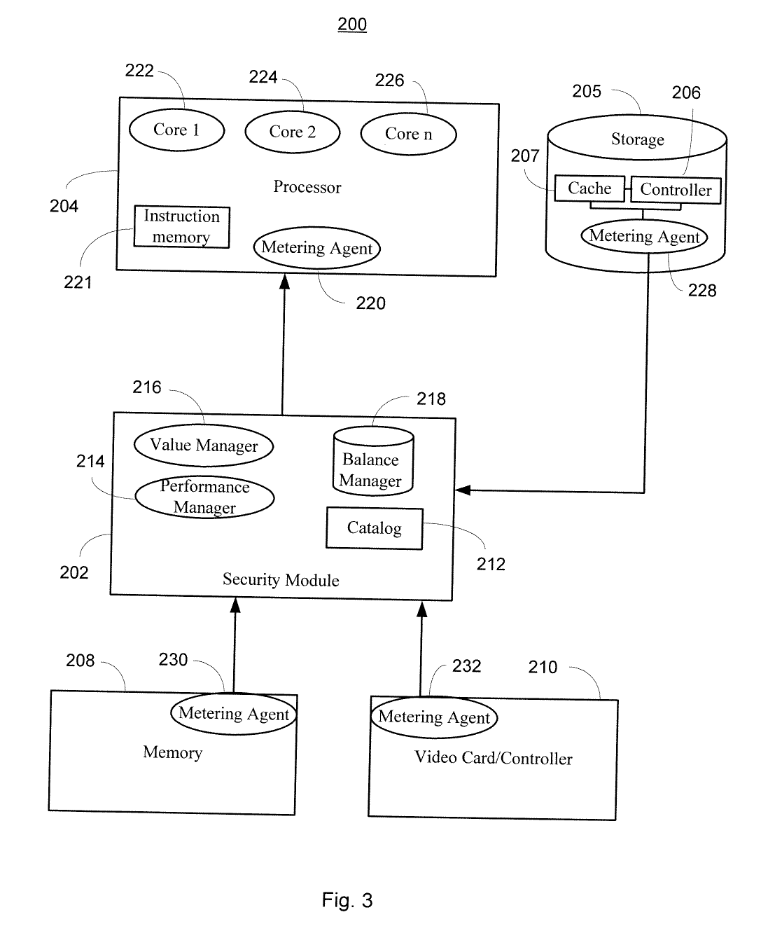

FIG. 3 is a block diagram illustrating a logical view of a computer 200, such as computer 110 of FIG. 1, showing details of a scalable use implementation. The computer 200 may include a security module 202 and one or more components adapted for use with varying levels of performance, as appropriate to the component. By way of example and not limitation, several exemplary components with scalable performance are illustrated in FIG. 2. The components may include a processor 204, a mass storage device, such as disk drive 205, a memory 208, and a video controller 210. The core function of each of these components is well known. Each component may incorporate a respective metering agent 220, 228, 230, 232 that allows scalable use of the core function of the component, as will be discussed in more detail below.

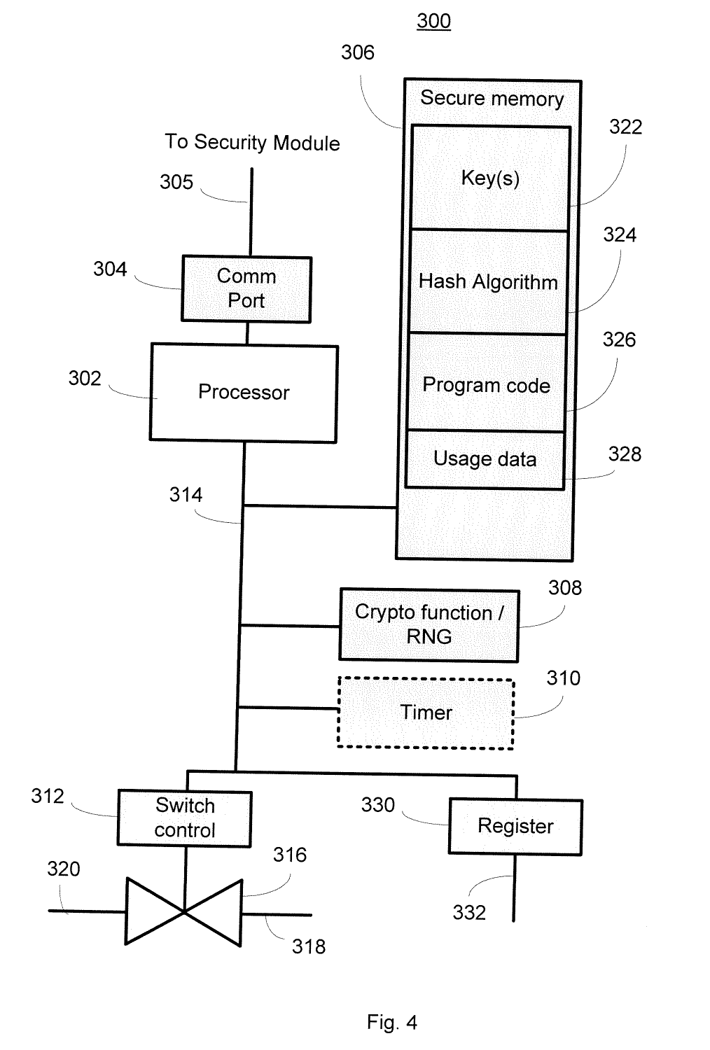

The disk drive 205 may include an integrated controller 206 and may also include a cache 207 of fast memory to store frequently accessed data. The disk drive 205 may also include metering agent 228. The metering agent is discussed in more detail with respect to FIG. 4 below. Briefly, the metering agent may manage setting a performance level for its associated component, in this case, the disk drive 205, and may also measures usage of the component, when required. Performance level in the disk drive 205 may be set by tuning one or more of cache size, data transfer rate, available disk space, etc.

To accomplish this, the metering agent 228 may take steps appropriate to the performance level being controller. If cache size is controlled, affecting overall read and write speed, the metering agent 228 may control a setting that manages cache memory allocation, similar to the way a BIOS controls overall memory configuration in a computer. That is, during operation, the controller 206 may receive configuration data information responsive to an event and the metering agent 228, in the role of the BIOS, may supply the configuration data according to the current performance level setting. The event that triggers such a programming of the controller may be the receipt of a new performance level setting at the metering agent 228.

If the data transfer rate is the controlled element, the metering agent 228 may set a clock speed that controls input and output FIFO memory clock rates (FIFOs not depicted). Disk space may be the controlled element. When managing disk space, some embodiments may only allow increases in disk space, at a corresponding increase in billing rate. However, once a limit is set, the metering agent 228 may enforce the limit by presenting a current maximum of space available when queried during a startup/reset process or by an operating system.

The processor 204 may include instruction memory 221, such as microcode, and may have one or more cores 222, 224, 226, for executing program instructions. The processor 204 may include metering agent 220. A metering agent embedded in a processor, such as processor 204, may have more implementation options than a metering agent used in other components. Because the processor 204 has so much control of computer operation, scalable use may be based on instruction set, memory used, execution speed, etc.

Processor 204 performance may be scaled by use of a greater or lesser number of cores 222, 224, 226. Processor 204 performance may also be scaled by clock rate (frequency), voltage, or a combination of both. Another form of managing performance is to limit access to the instruction memory, effectively disabling programs that use certain commands stored in the instruction memory 221. Many current processors also use frequency, voltage, or a combination of both, to manage performance.

The memory 208 may implement scalable performance in several ways, such as limiting the memory size or limiting the memory speed. The metering agent 230 may trap address commands above a certain address, slow the data clocking rate, or use a combination of both. Memory size limit changes may be restricted to restarts because an on-the-fly change in memory size may cause system instability, but dynamic page swapping algorithms may remove this restriction. Alternatively, or in combination with the memory 208, a bus controller (not depicted) associated with memory access may implement similar measures to restrict memory access.

Particularly in systems with memory controllers built into the processor 204, system performance may be managed by controlling the performance of the bus that connects the processor 204 to the memory 208 (for example, bus 124 of FIG. 2).

The video controller 210 may have a number of controls associated with scalable performance. For example, the metering agent 232 may have an ability to control or set a maximum limit on display resolution, color depth, 3D rendering, response rate, image frame rate, etc.

Each device or peripheral may be modified to allow its metering agent to control one or more settings related to performance. For example, in the video controller 210, registers (not depicted) that store user settings may be masked by a register that is controlled by the metering agent 232, allowing the metering agent to override the user settings. In the memory 208, the metering agent 230 could simply tri-state a high order address line to disable a portion of the memory, although more elegant solutions may be available through memory mapping and BIOS settings.

In an alternate embodiment, the computer 200 may simply monitor an automatically set performance level, rather than set it. Then, using the monitoring information, determine the value consumed during a session. For example, an application program may be able to request a certain performance level, which is then set by the performance manager 214. In one embodiment, the highest level of performance requested may be set, for example, supporting an interactive computer game. In another embodiment, the performance level may be an accumulation of individual performance level requests. E.g., using a performance level scale of 1-5, a browser may request level 1 and a word processor a level 2. The performance manager may set performance at level 3. To extend the illustration, the performance level may correspond to the number of cores 222, 224, 226 activated, such as level 1=1 core, levels 2-3=2 cores, levels 4-5=3 cores. Other performance level adjustments may be made in combination, such as adjustments to both cores 222, 224, 226 and memory 208.

Once the performance level is set, operation at the new performance level may be monitored and used to generate a usage value for a session. Each performance level may be billed at a different rate. The billing rate multiplied by operating time becomes a simple, easily monitored metric for accumulating the value of a session. The session value may either be subtracted from a local value account, such as a stored currency account, or may be accumulated and sent to a clearinghouse for settlement. In this scenario, implementation may require little or no hardware to implement performance management and value accumulation, since many performance settings can be made via software, as can usage time.

In yet another embodiment, the performance level may not be set at all, but an activity level of one or more components may be monitored to determine actual performance. For example, processor utilization, disk accesses, memory usage, bus traffic, etc. may all be used as indicators of activity level. A value may be associated with each of these metrics and either the value manager 216, the performance manager 214, or the balance manager 218 may be used to monitor the activity level and aggregate a total value associated with usage over a period of time. Thus, usage value may be charged at a rate corresponding to actual use. Measurement of activity level and calculation of an associated value may be performed in hardware in a security module 202 or may be performed in software. A software-only implementation may operate in a secure partition or at a protection level inaccessible by unauthorized users.

Devices with scalable resources and variable billing rates are not limited to computers. For example, the device of FIG. 3 may be a smart phone where the use of a word processor or movie viewer may be activated on demand and charged to the user's cellular telephone bill. Alternatively, the device of FIG. 3 could be part of a dashboard electronics package for an automobile. The scalable dashboard electronics resource could include navigation packages for local or distant areas, satellite radio, or a backseat video entertainment system.

FIG. 4 illustrates an exemplary metering agent 300, similar to the metering agents 220, 228, 230, and 232 of FIG. 3. One of the metering agent's functions may be the ability to securely receive and set an operating level for its respective component. This may require slight variations in the output structure, but the basic operations are similar. A second function of the metering agent 300, in some embodiments, may be an ability to measure usage and report it back to a security module or other controller, such as security module 202 of FIG. 3. In a simple device, such as a memory 208, measurement may not be significant, but for other devices, such as a disk drive 205, measurement of space allocated and used may be part of the calculation of a usage metric. In another example, a metering agent 220 in a processor 204 may monitor activity and report idle time vs. active processing time for use in determining usage. The reporting function may serve as confirmation that the selected level of performance is operational in the component.

The metering agent 300 may include a processor 302, a communication port 304, and a secure memory 306. The metering agent 300 may also include a cryptographic function 308, a timer 310 and one or more output interfaces. Illustrated in FIG. 4 are output interfaces such as switch control 312 and an associated switch 314, as well as a register 330 and bus 332. The memory 306, output interfaces 312, 330, and support functions 308, 310 may be coupled to the processor using a bus 314. The bus 314 may be any of several known busses, particularly one associated with the processor 302. For example, when the processor 302 is an ARM™ chip, the bus may be an AMBA™ interface.

The memory 306 may include keys 322, cryptographic algorithms 324, program code 326 and usage data 328 such as current performance level settings and usage metrics.

In operation, the metering agent 300 can accept commands from the security module 202 of FIG. 3 via a network connection 305 and the communications port 304. The network connection 305 may be a known bus, such as a serial peripheral interface (SPI) or a custom bus used for communication with the metering agent 300. In some embodiments, the metering agent 300 may be an addressable element of the component it is associated with, for example, a metering agent in a video controller, such as video controller 210 may be accessed as a register of the video controller 210.

The processor 302 may receive the command and interpret the command accordingly. For example, the command may indicate a performance level setting for operation of the metering agent's associated component, such as those shown in FIG. 3. The command may be encrypted to prevent fraudulent use or a denial-of-service attack. Once interpreted, settings associated with the command may be stored in the memory 306. The memory 306 may be tamper-resistant and may require an authentication sequence to alter, because of the risk of fraud following a successful attack on the memory 306. The keys 322 may be used to authenticate both commands received via the port 304 and for memory update authorizations, when the memory 306 is so equipped. The hash algorithm 324 or other cryptographic algorithms may be stored in the memory 306 instead of, or to supplement, the cryptographic function 308. The program code 326 may contain executable code used by the processor 302 for normal operation, including setting performance levels. Usage data 328 may be generated and stored during operation and transmitted to the security module 202 either periodically, or when polled.

The cryptographic function 308 may be used as part of a mutual authentication process with the security module 202 and for verification of commands received from the security module 202. A timer 310 may present when the metering agent 300 has a time-based requirement, such as either enforcing or measuring a duty-cycle based network access capability.

Output interfaces, such as the switch control 312 and the register 330, may be used to set scalable performance in a component. For example, the switch control 312 may operate the switch 316. The switch leads 318 and 320 may be used in any number of configurations. The switch leads 318, 320 may connect a tri-state bus driver to a logic high to disable an associated bus line. As another example, the switch leads 318 and 320 may be used to pull a normally high input signal to ground, changing the state of the input. As mentioned above, a register 330 may be used to interact with data or control registers in a component to affect operating settings, for example, video controller settings.

FIG. 5 illustrates a security module 400, similar to security module 202 of FIG. 3. The processor 402 may use communication port 404 to send and receive commands via bus 405 with both a system processor, such as processor 120 of FIG. 2 and metering agents, such as metering agents 220, 228, 230 and 232 of FIG. 3. Communication with the system processor may be to support external communication with a host or a fulfillment center 26 of FIG. 1 while communication with the metering agents 220, 228, 239, 232 may be to support transfer of scalable settings and metering data.

A memory 406 may store a number of data items and executable program modules. A cryptographic function 408 may include a random number generator for use in authentication processes. A timer 410 may be used to determine metering time periods. the timer 410 may also be used for setting a required period for communication with the host or fulfillment center 26.

The memory 406 may include data and executable software modules for implementing the functions of the security module. As mentioned above, the conversion between software implementations and hardware-based logic are well known. Although the functions of the security module 400 are described as being implemented in software, implementation in firmware or logic is a design-time decision.

Cryptographic keys 422 may be used as part of a message authentication process, for example, to authenticate messages with either metering agents 220, 228, 230, 232 or a fulfillment center 26. The message authentication process may include hashing, encryption or both and may incorporate either symmetric cryptography with message authentication codes or public key cryptography using encryption and digital signatures. If a dedicated cryptographic function 408 is not available or not used, cryptographic algorithms 424 may be used for message authentication or command verification. Program code 426 may include the stored executable instructions used by the processor 402 to implement message handling, balance management, usage value calculation, performance settings, etc.

A catalog 428 may be a listing of the settings available to a user for performance selections, including pricing associated with each setting. For example, a bundle may be presented to the user that includes selections for “Office,” “Gaming,” and “Browsing.” The Office bundle may include word processing and spreadsheet applications, medium graphics performance and two of three processor cores. The Gaming bundle may include no productivity applications but may include 3D graphics support and 3 of 3 processor cores. The Browsing bundle may include no productivity applications, medium graphics performance and high speed network interface.

Charging for the various bundles may be by bundle and by duration. For example, the Office bundle may be $1.00 per hour, the Gaming bundle may be $1.25 per hour and the Browsing bundle may be $0.80 per hour. The usage charges may be abstracted to “units/hour” to make currency conversions simpler. Alternatively, a bundle may incur a one-time charge that is operable until changed or for a fixed usage period. Other pricing techniques are apparent.

The catalog 428 may be stored as hypertext markup language (HTML) or in extensible markup language (XML) so that catalog data may be directly displayed to a user using a simple browser interface.

A balance manager 430 may manage and store an amount of credit that a user has available to apply to use of an electronic device incorporating the security module 400. The balance manager 430 may store value in currency, units of time, units of performance, etc. The balance manager 430 may manage actual cash or cash-equivalents, such as redeemable tokens. In another embodiment, the amount of credit may be maintained only as an approximation used as oversight and may be periodically reconciled to an actual balance stored elsewhere, such as at the fulfillment center 26. This local balance amount allows continued operation when access to the fulfillment center 26 is limited by using the approximation to provide a check on whether there is enough balance to pay for current operation.

A performance manager 432 may reflect the current performance setting and may be used to calculate a charge per minute or other charge per unit of measurement. In one embodiment, the performance manager 432 may set a billing rate according to a bundle price, such as $1.00 per hour for an office bundle. In another embodiment, the performance manager 432 may set a billing rate to be the sum of all individual component billing rates. To illustrate, if the video controller 210 is used at $0.25 per hour, 3 processors 222, 224, 226 are used at $0.85 per hour, and a high speed disk access is implemented at $0.20 per hour, the performance manager 432 may calculate a billing rate to be $1.30 per hour.

The value manager 434 manage the total value consumed in a current session. The value manager 434 may periodically send a current value to the balance manager 430 and then reset the current value to zero. Alternatively, the value manager 434 may accumulate value over a complete session and reconcile with the balance manager 430 at the conclusion of the session. Even though the current may not be subtracted from the balance, the value manager 434 and balance manager 430 may monitor each other, either one-way or mutually, to assure that the value is within a limit amount of the balance. The limit may be set above or below the actual balance to accommodate different terms and conditions related to charging and billing, credit history, etc.

When the value manager 434 is set to manage a one-time charge, the value manager 434 may be debit the balance at the beginning of a session. When the value manager 434 is set to accumulate value over time at a billing rate corresponding to the performance level, the accumulation of value may occur at a designated periodic interval.

In operation, data in the catalog 428 may be preloaded at the time of manufacture or during system configuration. Alternatively, the catalog 428 may be downloaded periodically after delivery to an end user. Updates to the catalog 428 are preferably encrypted and at least signed by a trusted party, such as the fulfillment center 26 of FIG. 1. The processor 402 may retrieve information from the catalog 428 in the memory 406 and supply it in response to a request initiated by a user. The user may make a selection and the response returned via the communication port 404 to the processor 402. The processor 402 may verify that the selection matches an available selection and then update the performance manager 432 with new operating characteristics.

The performance manager 432, as executed by the processor 402, may send messages to the appropriate metering agents associated with the updated performance selection. For example, if additional memory is to be authorized, metering agent 230 of FIG. 3 may be instructed via a cryptographically signed message to increase the memory available to the processor 204. Similar adjustments may be made by sending messages to the appropriate metering agents, such as metering agent 220, 228, and 232 of FIG. 3.

When the new configuration is confirmed, the value manager 434 may begin recording usage at the new performance level and accumulate value as activity occurs. Depending on the configuration, each metering agent may report activity and the value manager 434 may accumulate the reported activity in light of the billing rate to calculate a usage value. In one case, the metering agent may periodically calculate value according to billing rate and usage. In another embodiment, the value manager 434 may simply note the billing rate and the duration of a session. In the latter example, at the end of the session the accumulated value may be calculated once and sent to the balance manager 430 to be deducted from the available usage balance.

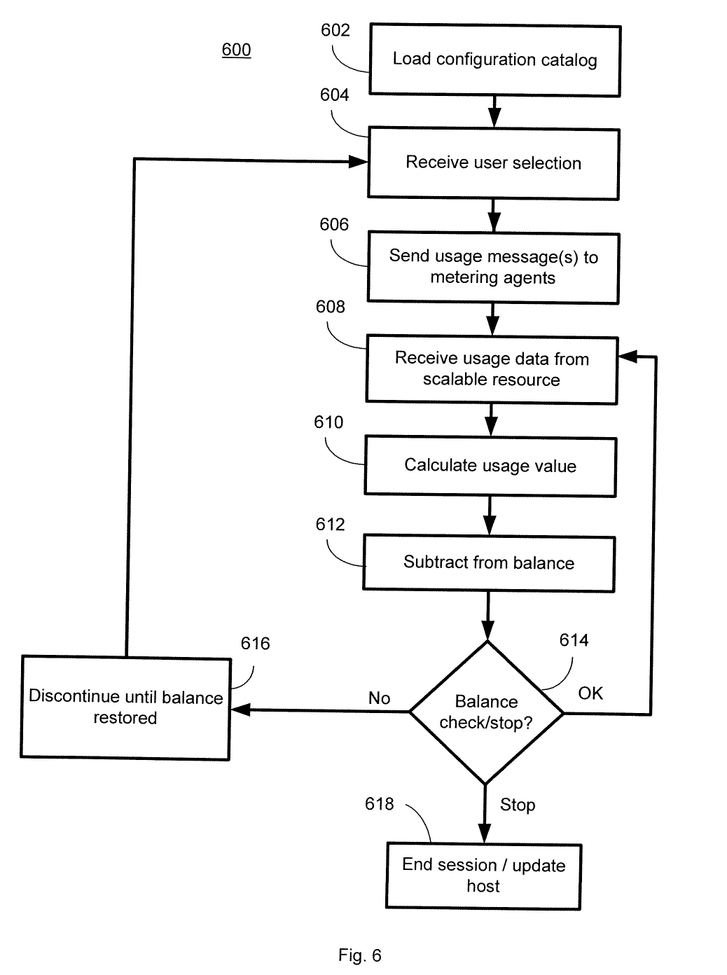

FIG. 6 illustrates a method 600 of setting a performance level of a computer and then metering the use of the computer at a rate according to the performance level selected. At block 602, a catalog with configuration options may be loaded into the computer, for example, into a security module 202. At block 604, the catalog 428 may be presented to a user for making a selection of a performance level. In one embodiment, exemplary performance levels may be associated with a type of task to be performed. For example, three performance levels may be associated with Web browsing at the low-end, office productivity in the midrange, and gaming at the high-end of performance. The office productivity performance level may also include particular software applications, such as word processing and spreadsheets.

After receiving a selection of performance level at block 604, at block 606, the security module 200 to may send messages to metering agents for appropriate scalable-use components associated with the selected performance level. Each message may include an identifier corresponding to a particular scalable component and a performance level. The message may be in a markup language, such as extensible markup language (XML) and may be signed, encrypted, or both.

To expand on a previous illustration, when enabling an office productivity performance level, a metering agent 228 associated with storage device 205 may be directed to decrypt the word processing and spreadsheet applications to enable them to be loaded and executed.

At block 608, the respective metering agents, such as metering agent 228, may return a metering message containing usage data to the security module 202 and the metering messages may be parsed to extract usage data. The metering messages from each metering agent may include a respective component identifier and usage data. The usage data may also include a confirmation of the current performance level setting. The usage data may also include an indication of usage or an on/off indicator, as appropriate to the actual component. For example, the metering agent 228 for the storage device 205 may send the number of disk accesses during a reporting period, while the metering agent 232 for the video controller 210 may only report the performance level and that the video controller 210 is active.

At block 610, the security module 202 may calculate a usage value. The usage value may be a simple single charge for use at a given performance level. Alternatively, a running charge may be developed by multiplying the rate times a usage metric. For a standard performance level, such as an office productivity performance level, a fixed fee per minute may be charged. In yet another embodiment, individual components may be charged at rates corresponding to the performance setting for that component. When the accumulated value for each of the scalable-performance components is added, the total value for usage may be calculated.

At block 612, a balance manager 218 may subtract the total value from a balance, such as prepaid stored value. When local stored value is not used, block 612 may be omitted. At block 614, status testing may be performed. When local stored value is used to pay for use, the remaining balance may be checked. When the balance has reached a limit, the no branch from block 614 may be taken to block 616. The computer may be disabled for beneficial use until the balance can be restored using a mechanism beyond the scope of this disclosure. When the balance is restored, operation may continue at block 604.

If, at block 614, the balance is within the limit established, the OK branch may be taken to block 608 and operation continued as above.

If, at block 614, an explicit quit command has been received, or if a change in performance level is requested, the branch to block 618 may be taken and the current session may be ended. If a local stored value account is not used, a reconciliation may be transacted with a host, such as the fulfillment center 26.

The host, such as the fulfillment center 26, may include a mediation system or the like, for accumulating the user's charges and performing transactions with user accounts to reconcile charges made locally. When different underwriters supply different hardware and software components of the computer 200, the billing/mediation system may distribute revenues according to a revenue sharing agreement.

In summary, a traditional business model for delivery of electronic devices, including computers, requires a large up front payment for hardware and software whether it is used continuously, routinely, or rarely. The system, components, and method described above disclose an alternative to the traditional business model. The alternative business model allows a user to select a configuration of hardware and software suited to the task being performed and then change the configuration as the user's requirements change.

Because users pay as they go, the initial purchase price of a computer may be significantly less than the purchase price of a comparable computer under the traditional business model. The user gets to select the exact performance they want for the task they are engaged in. Because of the pay-as-you go model, the user does not have a large investment sitting idle. On the other hand, the supplier/underwriter can set the business model to meet their financial targets with an on-going revenue stream over the life of the computer, not just a one-time purchase. While the user only pays for the performance they want, users gravitate to higher functionality, so the overall revenue to a supplier/underwriter may be higher over the life of the product when compared to a one-time purchase. Thus, both the consumer and the supplier benefit from this alternative business model.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A computing system supporting performance-on-demand resources comprising:
a metered resource supporting a function with scalable performance;
a metering agent coupled to the metered resource that sets a scalable performance level in a directive; and
a security module coupled to the metering agent for locally managing use of the metered resource, the security module comprising:
a value manager that accumulates a total value associated with the use of the metered resource according to the scalable performance level; and
a performance manager that receives a selection of the scalable performance level and sends the directive to the metering agent.

2. The computing system of claim 1, wherein the metering agent reports activity to the security module.

3. The computing system of claim 1, wherein the metered resource publishes a scalable performance range associated with the function.

4. The computing system of claim 3, wherein the performance manager verifies the selection of the scalable performance level against the scalable performance range associated with the function.

5. The computing system of claim 3, wherein the security module further comprises a balance manager that deducts value from a stored value account according to the metered resource and the scalable performance level selected.

6. The computing system of claim 3, wherein the security module further comprises a balance manager that accumulates usage data and transmits the usage data to a post-paid billing system.

7. The computing system of claim 1, wherein the metered resource is a graphics controller comprising a graphics resolution function with scalable performance.

8. The computing system of claim 1, wherein the metered resource is a scalable size storage function in a digital video recorder.

9. The computing system of claim 1, wherein the metered resource is a multiple core processor whereby a number of active cores is selectable in scalable offerings.

10. The computing system of claim 1, wherein the metered resource is a smart phone comprising features selectable in scalable offerings.

11. The computing system of claim 1, wherein the metered resource is a memory accessible is scalable portions.

12. The computing system of claim 1, wherein the metered resource is dashboard electronics comprising features selectable in scalable offerings.

13. A method of managing a scalable resource in a computing device comprising:
sending a message to the scalable resource, the message comprising a resource identifier for the scalable resource and a performance level;
receiving a metering message from the scalable resource comprising usage data;
extracting the usage data from the metering message;
calculating an adjusted usage data using usage data and the performance level; and
calculating a value corresponding to use of the scalable resource based on the adjusted usage data and a usage rate.

14. The method of claim 13, wherein the metering message further comprises the performance level and a usage time.

15. The method of claim 13, further comprising:
subtracting the value corresponding to the use of the scalable resource from a local stored value account.

16. The method of claim 13, further comprising:
sending the value corresponding to the use of the scalable resource to a remote billing system.

17. The method of claim 13, wherein the scalable resource is one of a graphics controller, a memory, a digital video recorder, and a smart phone.

18. A metering agent for use in a component of an electronic device, the component operating over a scalable range of performance and comprising:
a port for communication with a metering manager;
a processor coupled to the port for monitoring a performance level of the component; and
a balance manager that accumulates a value for use of the electronic device at the performance level.

19. The metering agent of claim 18, wherein the performance level is a function of a current usage level of the electronic device.

20. The metering agent of claim 18, wherein the performance level is automatically set according to a performance requirement of an application running on the electronic device.
